(19) United States
(12) Patent Application Publication
(10) Pub. No.: US 2002/0148976 A1
(43) Pub. Date: Oct. 17, 2002

(54) Thermal control of image pattern distortions

(76) Inventors: Alfred Chalupka, Vienna (AT); Ernst Haugeneder, Vienna (AT); Gertraud Lammer, Vienna (AT)

Correspondence Address: WYATT, GERBER, MELLER & O ROURKE, L.L.P., 99 PARK AVENUE, NEW YORK, NY, 10016, US

(21) Appl. No.: 10/098,853

(22) Filed: Mar. 14, 2002

(30) Foreign Application Priority Data
Mar. 19, 2001 (AT) A 434/2001

(51) Int. Cl. G21G 5/00

(52) U.S. Cl. 250/492.2

(57) ABSTRACT

In a masked lithography system (100) a mask (102) with a mask pattern is imaged onto a target (104) by means of a lithography beam (101, 103). For controlling image pattern distortions, a plurality of metrology structures are provided in the mask and are imaged onto a metrology means (150). There, the positions of images of the metrology structures are measured; these positions are compared with respective nominal positions, and a plurality of radiation intensities, each associated to a respective location on the mask, are calculated in a control unit (200). The locations on the mask are heated with the respective radiation intensities by means of a radiation projector means with a radiation source (300) positioned outside the lithography beam path; the heating of the mask thus effected generates distortions in the mask pattern due to local thermal expansion. The distortion control procedure may be iterated in a feedback loop.

### FIELD OF THE INVENTION AND DESCRIPTION OF PRIOR ART

The present invention relates to the control of image pattern distortions of a lithography system in which a mask pattern on a mask is used to be imaged onto a target by means of a lithography beam of particles or electromagnetic radiation.

In masked particle lithography, in order to define a structured layer on a substrate—e.g., a resist covered semiconductor wafer—an aperture pattern which is formed in a mask is imaged by means of a particle beam or, in particular, ion beam onto the substrate using a particle-optical system. Due to the high requirements with regard to the accuracy of the structure formed on the substrate, any changes in the mask aperture pattern during the exposure that may lead to distortion of the image pattern must be ruled out. The primary source of distortions in the mask is thermal expansion which takes place when the temperature of the mask or portions of the mask deviates from a preset operating temperature. Beside thermal effects, distortions can be caused also by other reasons, such as stresses in the mask or ageing of the mask material. Similarly, distortions of the imaged pattern that result from irregularities in the optics or in the environment must be avoided.

The U.S. Pat. No. 4,916,322 (=EP 0 325 575 A2) describes a lithographic system including a mask-exposure station and a cooling surface which is disposed in the field of view of the mask exposure station and surrounding the optical path of the beam wherein energy deposition on the mask by the beam can be compensated by thermal radiation from the mask to the cooling surface. In this arrangement a mask foil which is substantially free of distortion can be used in such a manner that the stresses in the mask sheet will remain within a permissible range even during operation so that the structure of the permeable portion will reliably be reproduced under the irradiation load. This arrangement provides thermal stabilization of the mask; however, it only deals with the mask as a whole and furthermore does not allow for correction of unwanted distortions which are present despite thermal stabilization, e.g. due to local thermal variations or non-thermal effects.

M. Feldman, in “Thermal compensation of X-ray mask distortions”, J. Vac. Sci. Technol. B 17(6), November/December 1999, pp. 3407-3410, demonstrated that heating of a mask membrane can be used for correction of distortions present in the membrane. In that article a special setup corresponding to X-ray proximity printing is used wherein the mask is thermally stabilized by heat conduction over a gap to the substrate to be exposed. First, a sacrificial wafer is exposed and developed, and distortions are measured on the developed sacrificial wafer. In consecutive exposures, in order to compensate the distortions as found, two light beams are scanned over the surface of the mask during exposure with varying light intensities to introduce heat corresponding to the distortion compensation at the irradiated spot. The method is complicated as it requires direct measurement of the pattern features produced on the substrate and a full development step of a send-ahead wafer. Moreover, a feedback control with respect to the efficiency of the distortion correction is not possible with the method of that article.

### SUMMARY OF THE INVENTION

The present invention aims at a method for control of image pattern distortions in a lithography system which can be used in a production line without wasting a sacrificial wafer and which makes possible a fast determination and correction of distortions.

This aim is met by a method as set forth in the beginning, wherein in the lithography system, the following steps are performed: The positions of images of a plurality of metrology structures are measured in a metrology means; the metrology structures are provided in the mask and are imaged by means of the lithography beam onto the metrology means. The positions thus determined are compared with respective nominal positions and respective position deviations are determined. From these deviations a plurality of radiation intensities is calculated, wherein each of these radiation intensities is associated to a respective location on the mask and has a value between zero and a maximal intensity. For each radiation intensity the corresponding location on the mask is heated by a heating radiation of said intensity. For this, a radiation source positioned outside the path of the lithography beam is used, wherein the heating of the mask thus effected generates distortions in the mask pattern due to local thermal expansion.

This solution makes the control, in particular the correction, of distortions in the image pattern produced from the mask pattern possible, including distortions of a local nature as well as of overall distortions of the pattern. The invention uses the concept of metrology which is adapted in order to also correct defects of the imaged pattern which are beyond a correction by the optical system. The distortion control is not delimited to deformations in the mask, but can be used to correct distortions caused from other influences, such as optical errors; nor is it delimited to thermal distortions.

Preferably, the determination of the radiation intensities is performed in a metrology step of its own which is performed before actual exposure of targets. After the metrology step, at least one exposure step for exposure of a target is performed during which the mask is heated by the heating radiation with the radiation intensities as determined in the metrology step.

Advantageously, in particular with mask materials with high absorptivity for visual light, the heating radiation is produced by a projector means as visible light. This facilitates implementation and inspection of the heating system, as components developed for visual use (video-components) can be used.

In a further aspect of the invention, the radiation source is positioned outside a housing encasing the lithography system, and the heating radiation is projected into the lithography system and onto the mask through a window provided in the housing. By virtue of this arrangement, the major components of the heating system can be handled and operated without interfering with the main parts of the lithography device, in particular the optical system accommodated in a vacuum space.

Preferably, the heating radiation is directed from the radiation source to the mask by means of a heating radiation projector system. The heating radiation optical system may comprise a composite mirror which in turn comprises a plurality of mirror elements, and each of the mirror elements directs heating radiation led to the element into one of at least two selectable directions, of which one direction leads the heating radiation towards a respective location on the mask, and another direction towards an absorbing surface.

Often, the number of mirror elements is far higher than the number of locations on the mask. Then, a set of mirror elements may be dedicated to heat one location of the mask. Furthermore, the radiation intensity directed to a location on the mask can be obtained by directing only a number of mirror elements of the set to irradiate the mask, the number (with respect to the total number of elements in the respective set) corresponding to the proportion of the radiation intensity with respect to the maximal intensity. The remaining mirror elements of the set are directed to irradiate the absorbing surface.

Alternatively, the radiation intensity directed from a mirror element to the respective location is obtained by frequent change of the respective mirror element(s). In this case, the quota of the time where the radiation is directed to the mask corresponds to the proportion of the radiation intensity with respect to the maximal intensity.

In a preferred aspect of the invention, the procedure of distortion control is iterated, thus realizing a feedback control loop. After irradiating the mask with radiation intensities determined in a first run, at least one iteration run is performed, wherein in each iteration run, the steps of the distortion control as described above are repeated with respect to the positions of the structure images as present in the mask heated with radiation intensities determined in the previous run and the radiation intensities thus calculated are used as correction to the respective radiation intensities of the previous run.

### BRIEF DESCRIPTION OF THE DRAWINGS

In the following, the present invention is described in more detail with reference to the drawings, which show:

FIG. 1 a schematic footprint of an ion beam projector system;

FIG. 2 the radiation source and the additional heating of the mask in the projector system of FIG. 1;

FIG. 3 the metrology and pattern lock system of the projector system of FIG. 1; and

FIG. 4 the corresponding metrology arrangements in the mask and in the metrology unit of the system of FIG. 1.

### DETAILED DESCRIPTION OF THE INVENTION

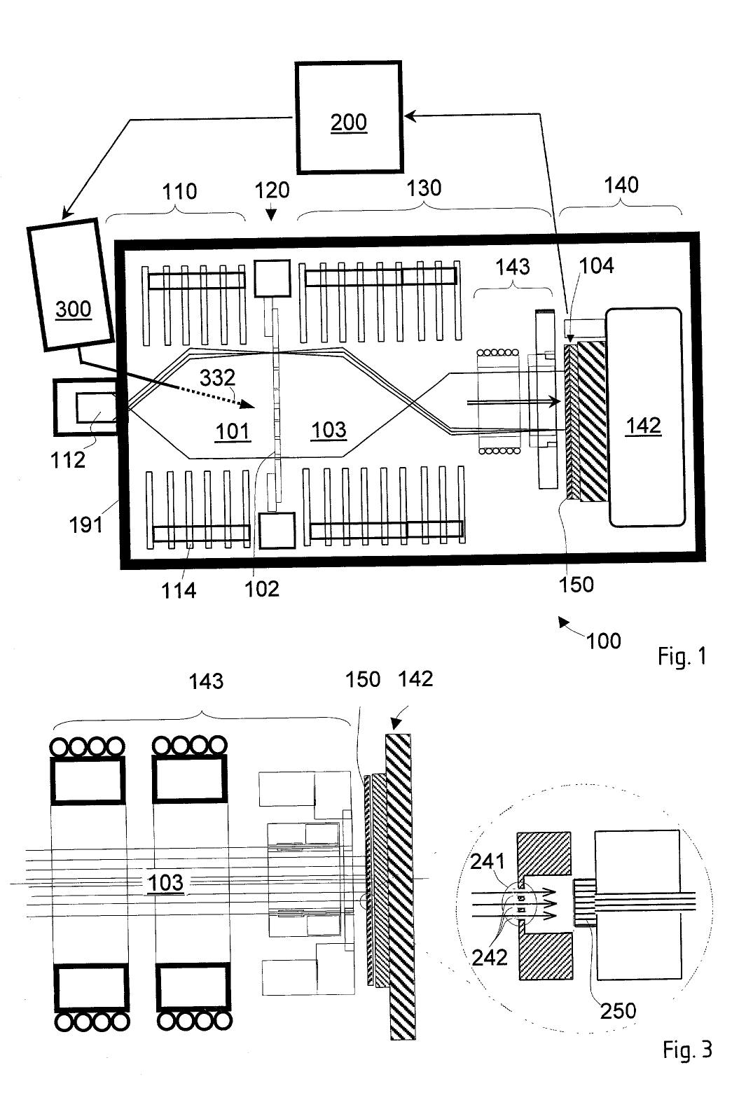

In the context of an ion beam projector shown in FIG. 1, a preferred realization of the invention is discussed in the following. In this lithography projection system 100, an ion beam 101—running from left to right in FIG. 1—is projected onto a stencil mask 102 provided with a mask pattern, producing a patterned beam 103 with the information of the mask pattern formed in the mask, and using the patterned beam 103 the mask pattern is imaged onto the target plane 104 in a target station 140.

The lithography system 100 is described here only as far as required to illustrate the invention. Further details of the preferred lithography system, in particular with respect to the metrology and alignment systems, are described in the U.S. Pat. No. 4,985,634 (=EP 0 344 646 A2).

The ion beam 101 is generated by an illumination system 110 comprising an ion source 112 with an extraction system (not shown) fed by a gas supply (not shown). In the preferred embodiment, helium ions are used; it should, however, be noted that other ions, e.g. hydrogen ions, can be applied as well, and that the invention in general is well suited to any kind of particle or electromagnetic radiation (e.g., X-ray) used for imaging. The ion source 112 emits ions of defined energy which, by means of the condenser lens 114, are formed into a substantially homocentric or, preferably, telecentric beam 101.

The ion beam 101 is projected onto the stencil mask 102 mounted in a mask assembly 120. The mask assembly 120 positions the mask 102 at a defined position in the path of the beam 101. The mask 102 has a membrane in which apertures—i.e., regions transparent to the radiation, at least of that portion with the required energy, of the illuminating beam 101—are provided. The ion beam 101 penetrates the mask only through the apertures, at least the portion with the required energy, to form the patterned beam 103. The patterned beam 103 is then imaged by the imaging system 130 onto a target plane 104 in a target station 140 where it forms an image of the mask apertures. In this context, ‘required energy’ refers to the specific radiation needed for exposure of the target in the target station 140.

During the actual exposure, the pattern image formed at the target plane 104 is used for exposure of, e.g., a resist layer on a silicon wafer. For this, the system 100 comprises a target station 140, comprising a wafer stage 142 and an alignment system 143, which is adapted to hold and position the silicon wafer (not shown) at a precise position with respect to the image produced on it. Before the exposure of wafers, however, the positioning and quality of the image generated at the target plane are examined in a so-called metrology procedure. This is done by means of a metrology unit 150 which is provided in the system 100 and positioned in place of a wafer during the metrology procedure.

The principles of metrology systems are described in detail in the U.S. Pat. No. 4,985,634. There, by means of a metrology system the imaging properties of the ion-optical system used in the lithography system 100 are determined in order to detect imperfections in the ion-optical imaging; by means of metrology it is possible to adjust the ion-optical parameters in order to maintain a desired image quality. According to the invention, the metrology system is additionally used to probe for distortions of the pattern image formed in the target plane.

In the image generated at the target plane, distortions may be present which can be due to distortions in the mask membrane (due to mechanical and/or thermal deformation), optical errors of the ion-optical system or other reasons. These distortions may affect the image as a whole or only some part of the image. It is noteworthy that the layout of the aperture pattern in the mask may differ in a predetermined manner from the desired image pattern, in order to compensate for image distortion effects in the lithography tool 100 which were anticipated beforehand.

According to the invention, the metrology unit 150 is used to determine image distortions before the actual exposure procedure. The image distortions thus determined are used to calculate corrections which are applied by introducing corresponding distortions into the mask which compensate the present image distortions. The mask distortions are produced by local heating of the mask by means of a radiation source 300 and thermal expansion of the mask material thus heated. The heating radiation 332 produced by the radiation source 300 can, in principle, be any radiation suitable to introduce heat to the mask, such as light in the IR, visible or UV range, corresponding to the material of the mask foil. In the embodiment discussed here, the mask is formed from a semiconductor wafer, in particular, a silicon wafer. Preferably, the correction procedure is performed in an iterative manner, i.e., after the first correction with the help of local heating, the image thus corrected is measured again, and new corrections are determined in order to derive a profile of additional heating correction, and this is repeated until the image distortions have converged to a minimum or acceptable residue of image distortions.

After an optimal correction of distortions has been obtained, the condition of the imaging system, in particular the thermal state and position of the mask, are kept constant, while the metrology unit is moved out of the beam path and the first wafer is moved in on the target stage in order to start the exposure procedure of the wafer. The position of the pattern image and the wafer are controlled to high accuracy by means of the alignment system 143. Further details to the alignment system are disclosed in the U.S. Pat. No. 4,967,088 (=EP 0 294 363 A2).

It is an important aspect of the thermal control of distortions according to the invention that heat conduction within the mask is of minor influence. Cooling of the mask, which compensates the heat introduced from the radiation source, is mainly achieved by thermal radiation.

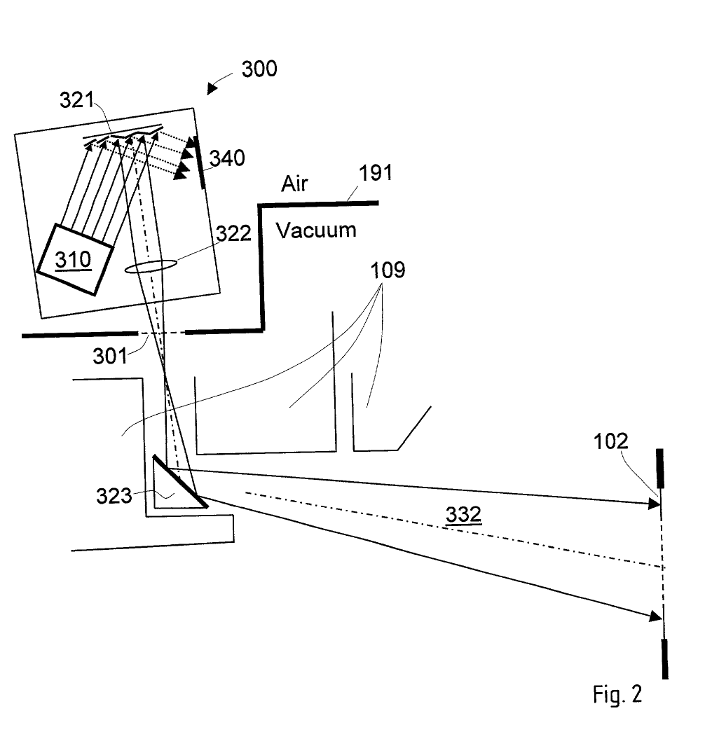

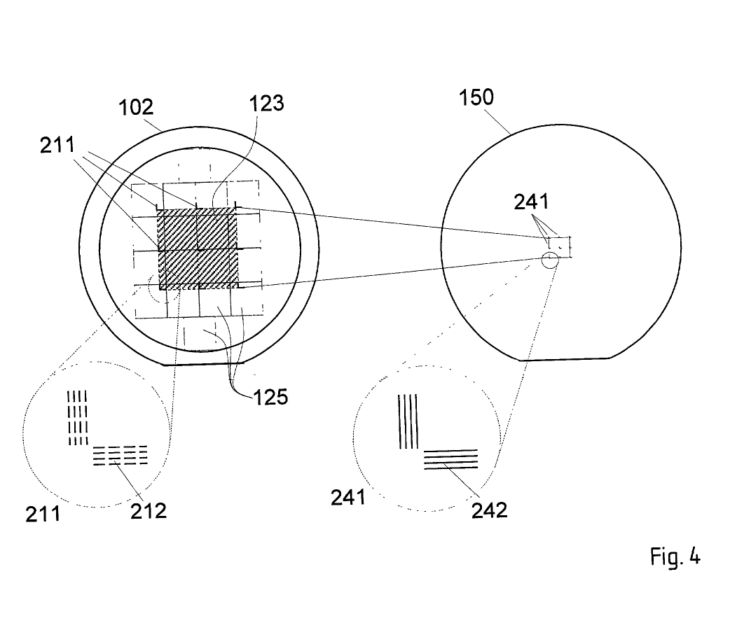

Referring to FIG. 4, the determination of the distortions is done with the help of metrology structures 211 defined beforehand in the mask foil, as part of the mask pattern, preferably as a group of metrology marks 212. The metrology structures produce metrology beamlets which are imaged onto the metrology unit 150. In the metrology unit 150, shown in detail in FIG. 3, the positions of the metrology beamlets are measured by means of registration structures 241 comprising a set of metrology slits 242. The shape and mutual arrangement of the metrology slits corresponds to the metrology marks 212 in the mask foil, as well as their sizes and mutual distances; it should be noted that in the embodiment shown here, the imaging optics system employs a demagnification of 4× and consequently the dimensions of features on the metrology plate are reduced accordingly with respect to those of the mask; in the two details of FIG. 4 showing a metrology structure 211 and a registering structure 241 respectively, the metrology marks 212 and slits 242 are not to scale.

Referring to FIG. 3, one embodiment of the metrology unit 150 consists of a metrology plate with metrology silts 242 corresponding to the respective marks 212 (FIG. 4) in the mask. Behind each set of metrology slits 241, a current measurement unit 250 is provided. To measure the position of the metrology beamlets in the image plane, the whole beam may be displaced laterally with respect to the target plane, e.g. by an alternating dipole field applied to the pattern lock multipoles resulting in a sweeping motion during which the ion current penetrating through each set of metrology slits is measured. The position of the metrology beamlet is derived from the dependence of the current on the applied dipole field. From the positions thus determined, respective deviations are derived with respect to nominal positions which correspond to the actual desired positions of the metrology structures for a nondistorted image. The nominal positions may be positions defined during the design of the chip field pattern which is to be formed lithographically. Alternatively, as nominal positions the positions of a previous design layer may be used, which may deviate from the original design positions due to production history.

The metrology structures are positioned on the mask at measuring points arranged, preferably, in a regular array defined beforehand over the area of the mask pattern as shown in FIG. 4. In the following, the measuring points are referred to as Pₘ identified by an index m which runs from 1 to the total number N_{M} of measuring points. Even in the case of a large number of metrology structures, such as N_{M}=13×13, the total area of the metrology structures can be kept small, i.e., only a small fraction—typically, less than 1/1000—of the total pattern field which is used, e.g., for a wafer chip field. The metrology unit comprises a corresponding number N_{M} of measuring units for measuring the position of the respective metrology beam image.

In a like manner, a set of areas 125 (‘locations’) is defined on the mask which may be heated for correction of distortions (see FIG. 4). The areas 125 are defined in advance on the mask area in a suitable manner during implementation of the radiation projector means 300 discussed below. In the following, similar to the positions Pₘ of the metrology structures, the locations 125 are referred to as Lⱼ identified by an index j which runs from 1 to the total number N_{L} of locations. Each location Lⱼ can be heated individually by being irradiated with the radiation emitted from the radiation source 300. Further shown in FIG. 4 is the design pattern area 123 which is the area of the mask pattern, also comprising the metrology structures 211.

In general, heating a single location Lⱼ will affect the distortions at all measuring points Pₘ. In the following, the effect to the displacement vector of measuring point Pₘ resulting from heating of the location Lⱼ with unit intensity is referred to as uₘⱼ. For the case that the whole set of mask locations Lⱼ is heated with radiation intensities wⱼ, respectively, the resulting displacement rₘ at the point Pₘ is given by

rₘ=Σuₘⱼ·wⱼ (1)

where the sum covers all locations j=1, . . . , N_{L}. The distortion correlations uₘⱼ are determined beforehand, e.g., in a finite element calculation taking into account the actual pattern structuring of the mask membrane. Equation (1) represents the assumption that the effects of thermally induced distortions superpose in a linear manner which will hold for distortions not too large.

In order to compensate a set of distortions dₘ actually measured at the metrology unit, radiation intensities Wⱼ are sought which give rise to distortions rₘ compensating the measured ured distortions, i.e., rₘ−dₘ. This gives a linear set of equations for the intensities wⱼ, j=1, . . . , N_{L}:

dₘ=−Σuₘⱼ·wⱼ, m=1, . . . , N_{M} (2)

In the preferred embodiment shown here, the numbers of measuring points and locations are related as 2 N_{M}=N_{L}. Then for given distortions dₘ, Eq. (2) yields a unique solution for the set of intensities wⱼ. For instance, with reference to FIG. 4, N_{M}=9 and N_{L}=18. In another embodiment, the number of heated locations, N_{L}, is smaller than 2 NM; in this case, the solutions of Eq. (2) are found by a best fit.

As already mentioned, Eq. (2) was formulated under the assumption that the linear approximation is valid. Thus, non-linear effects will cause residual distortions to be present even when applying a heating with intensities as calculated from the direct approach as discussed above. In order to further improve the correction of distortions, the above procedure may be iterated. Thus the distortions can be minimized step by step.

In this iterated scheme, after applying a set of radiation intensities wₘ to the mask, the residual distortions d′ₘ are measured at the metrology site. From these distortions d′ₘ, new incremental radiation intensities w′ₘ are calculated in an analogous manner to the method described above, i.e. by solving the linear set of equations

d′ₘ=−Σuₘⱼ·w′ⱼ (3)

The incremental intensities w′ₘ are then used to correct the intensities wₘ, e.g. by adding them, obtaining corrected intensities wₘ^{(new)}=wₘ^{(old)}+w′ₘ. This procedure can be iterated until the set of intensities thus corrected converges or the residual distortions d′ₘ have fallen below a predetermined limit.

This iterative procedure corresponds to a modified Newton-Raphson iteration method. For this method to work it is sufficient that the coefficients uₘⱼ are estimates only.

Preliminary studies indicate that the distortion correction according to the invention converges to an optimal correction having negligible residual image distortions with only few iterative steps, the number of steps depending on the accuracy required.

In the preferred embodiment, a metrology control unit 200 receives the data relating to the positions of the metrology beam images from the metrology unit, and calculates correction data, i.e., radiation intensities, from these data by using the above-described algorithm. The correction data are fed to a radiation projector means 300 for adjusting the radiation intensities with which the locations on the mask are heated accordingly. The metrology control unit 200 may, for instance, be realized as part of the computer control system of the lithography system 100.

The radiation projector means 300 according to the invention is shown in detail in FIG. 2. In the embodiment shown here, the projector means 300 comprises a radiation source emifting visible light as this type of radiation is particularly suitable for silicon foils of 1-3 μm thickness. As radiation source 310 a suitable light source, such as a video projector used for the projection of computer video output (so-called beamer), is used to produce a beam of visible light. The projector means can be positioned outside of the housing 191 of the lithography system, and the light is led into the lithography system 100 through a window 301 provided in the lithography housing. Thus, the projector means can be operated under usual atmospheric conditions and does not interfere with the vacuum present within the lithography system 100 (of which only a few components 109 are outlined schematically in FIG. 2).

An appropriat ely chosen set of mirrors 321, 323 and lenses, including the objective lens 322 of the projector means 300, directs the beam onto the mask 102. One of the mirrors, in embodiment shown here the first mirror 321, is realized as a composite mirror means which controls the radiation intensities relating to the heated locations on the mask 102. Within the lithography system, a second mirror 323 is provided to direct the beam which enters through the window 301, i.e., more accurately, the bundle of beams 332, to the mask 102.

The composite mirror 321 is used to control the intensity of the light irradiated to the different locations on the mask 102. The composite mirror comprises a multitude of mirror elements which can be switched on or off. In the switched-on state, the mirror elements reflect the incoming light to the direction of a target, which then is illuminated; in the switched-off state, the light is reflected out, for instance to an absorbing surface 340 provided next to the mirror 321. The mirror elements are oriented such that the locations Lⱼ on the mask can be illuminated individually to effect the heating according to the invention. By using a group of mirror elements for each location Li on the mask, respectively, and/or by quickly switching on and off a mirror element with a desired on/off ratio, the intensity of light directed to one location Lⱼ on the mask can also assume intermediate values between zero and 100% of the maximal intensity available. A mirror device suitable as composite mirror is described by J. B. Sampsell, in “Digital micromirror device and its application to projector displays”, J. Vac. Sci. Technol. B 12(6), November/December, 1994, pp. 3242-3246.

We claim:

1. A method for controlling image pattern distortions in a masked lithography system (100) using a mask (102) comprising a mask pattern (123) being adapted to be imaged onto a target by means of a lithography beam (101, 103) of particles or electromagnetic radiation wherein in the lithography system (100),
a plurality of metrology structures (211) provided in the mask (102) are imaged by means of said beam (103) onto a metrology means (150), the positions of the images of the structures are measured in the metrology means,
the positions thus determined are compared with respective nominal positions and respective position deviations are determined, from these deviations a plurality of heating radiation intensities are calculated, each heating radiation intensity being associated to a respective location (125) on the mask (102) and having a value between zero and a maximal intensity,
and for each heating radiation intensity the corresponding location (125) on the mask is heated by a heating radiation (332) of said intensity from a radiation source (310) positioned outside the path of the lithography beam (101, 103), wherein the heating of the mask thus effected generates distortions in the mask pattern due to local thermal expansion.

2. The method according to claim 1, wherein
the determination of the heating radiation intensities is performed in a metrology step, and after the metrology step, at least one exposure step for exposure of a target is performed during which the mask is heated by the heating radiation with the heating radiation intensities.

3. The method according to claim 1, wherein
the heating radiation (332) is produced by a light source (310) as visible light.

4. The method according to claim 1, wherein
the radiation source (310) is positioned outside a housing (191) encasing the lithography system (100), and the heating radiation (332) is projected into the lithography system and onto the mask through a window (301) provided in the housing.

5. The method according to claim 1, wherein
the heating radiation (332) is directed from the radiation source (310) to the mask (102) by means of a heating radiation projector system (300).

6. The method according to claim 5, wherein
the heating radiation optical system (300) comprises a composite mirror (321) which comprises a plurality of mirror elements, and each of the mirror elements directs heating radiation led to the element into one of at least two selectable directions, of which one direction leads the heating radiation towards a respective location (125) on the mask, and another direction towards an absorbing surface (340).

7. The method according to claim 6, wherein
a set of mirror elements is dedicated to heat one location of the mask.

8. The method according to claim 7, wherein
the radiation intensity directed to a location (125) on the mask is obtained by directing a number of mirror elements of the set to irradiate the mask, the number corresponding to the proportion of the radiation intensity with respect to the maximal intensity, the other mirror elements of the set being directed to irradiate the absorbing surface (340).

9. The method according to claim 6, wherein
for a mirror element, the radiation intensity directed to the respective location (125) is obtained by frequent change of the mirror element(s), the quota of the time where the radiation is directed to the mask corresponding to the proportion of the radiation intensity with respect to the maximal intensity.

10. The method according to claim 1, wherein
after irradiating the mask with radiation intensities determined in a first run, at least one iteration run is performed, wherein in each iteration run, the steps as described in claim 1 are repeated with respect to the positions of the structure images as present in the mask heated with radiation intensities determined in the previous run and the radiation intensities thus calculated are used as correction to the respective radiation intensities of the previous run.

11. A lithography system (100) comprising a mask (102) comprising a mask pattern (123), a target station (140) comprising a metrology means (150), and means to generate a lithography beam (101, 103) of particles or electromagnetic radiation and to image said mask pattern (123) onto a target in the target station (140) by means of said beam (101, 103), the lithography system being adapted to image a plurality of metrology structures (211) provided in the mask (102) by means of said beam (103) onto the metrology means (150), the metrology means being adapted to measure the positions of the images of the structures, lithography system comprising means (200) to compare the positions thus determined with respective nominal positions and determine respective position deviations, as well as calculate from these deviations a plurality of heating radiation intensities, each heating radiation intensity being associated to a respective location (125) on the mask (102) and having a value between zero and a maximal intensity, the lithography means further comprising a radiation source (310) positioned outside the path of the lithography beam (101, 103), the radiation source being adapted to heat locations on the mask (102) by a heating radiation (332) and thus generate distortions in the mask pattern due to local thermal expansion, wherein for each heating radiation intensity the corresponding location (125) on the mask is heated with said intensity.
